(19) United States
(12) Patent Application Publication
(10) Pub. No.: US 2025/0256600 A1
(43) Pub. Date: Aug. 14, 2025

(54) CONFIGURABLE CHARGE POINT OPERATOR (CPO) QUICK-RESPONSE (QR) CODE FOR SEAMLESS COMMISSIONING OF SCREENLESS ELECTRIC VEHICLE (EV) CHARGERS

(71) Applicant: Siemens Industry, Inc., Alpharetta, GA (US)

(72) Inventor: Daniel Feldman, New York, NY (US)

(73) Assignee: Siemens Industry, Inc., Alpharetta, GA (US)

(21) Appl. No.: 18/440,080

(22) Filed: Feb. 13, 2024

(51) Int. Cl. B60L 53/30; B60L 53/68; G06K 7/14

(52) U.S. Cl. CPC B60L 53/305; B60L 53/68; G06K 7/143

(57) ABSTRACT

A screenless EV charger such as an Electric vehicle supply equipment (EVSE) includes a configurable CPO QR code for seamless commissioning. The EV charger comprises a body and a QR code printed on the body. The QR code includes a URL of an EVSE manufacturer followed by a serial number or Device ID. The QR code covers all CSMSs with a single product SKU. The QR code redirects automatically to a desired CSMS, with compatibility to work with more than one CSMS. When a user lands on the URL with a web browser, a Webapp looks up a table that indicates what is a redirection URL of the CSMS that actually manages the EV charger such that the QR code never has to change, and an association of the EV charger to a CSMS is enough for the QR code to direct the user to a desired Webapp.

### BACKGROUND

### 1. Field

Aspects of the present invention generally relate to configurable Charge Point Operator (CPO) quick-response (QR) code for seamless commissioning of screenless Electric vehicle (EV) chargers.

### 2. Description of the Related Art

EV chargers are commonly designed to be controllable by Charging Station Management Systems (CSMS) offered by different companies. For this purpose, many EV chargers use the Open Charge Point Protocol (OCPP), which allows the interoperability. When a customer purchases an EV charger, it configures the EV charger either directly or remotely through a management Application Programming Interface (API) (which could be also OCPP-based, or proprietary), to indicate to the EV charger the Uniform Resource Locator (URL) of the CSMS it needs to communicate with. A common feature of a CSMS is to provide a Webapp that can be used by an anonymous driver wanting to start a charging session. The Webapp control method removes the need to install a CSMS-compatible application on a phone and identifying the user to control the EV charger. For this webapp to work, the driver needs to, using a smartphone, scan a QR code attached to the EV charger. The QR code, normally is equivalent to a URL followed by a serial number or Device ID of an EV charger such as an Electric vehicle supply equipment (EVSE) (e.g. https://smart.juice.net/pay/0817091001040441042118249203 is equivalent to a QR code). While this method works, it requires either the EVSE manufacturer to create a custom SKU (stock keeping unit) for each combination of EV charger and CSMS the EV charger is supposed to operate with (which is problematic logistically), or for a QR code sticker to be added to the product at installation time (when the CSMS is known), which can lead to human mistake in placing the correct QR code on the correct EV charger, as well as to a delay from installation time until the EV charger is fully operational with drivers being able to use the Webapp to charge.

As described above, the problem has been solved in two methods which are non-optimal either from the logistical point of view or from the error proneness and time to get chargers working point of view.

Therefore, a system is then needed for configurable Charge Point Operator (CPO) quick-response (QR) code of Electric vehicle (EV) chargers.

### SUMMARY

Briefly described, aspects of the present invention relate to a system and a method for providing a configurable Charge Point Operator (CPO) quick-response (QR) code on Electric vehicle (EV) chargers. The idea is to always print a QR code that includes a URL owned by an EVSE manufacturer followed by a serial number or a Device ID of an EV charger such as an Electric vehicle supply equipment (EVSE) (e.g. if Siemens manufactures the EV charger, it would be evcharging.siemens.com/pay/1234567890). When a user lands on that URL with a web browser, the Webapp, instead of looking up the EV charger on a specific CSMS, looks up a table that indicates what is the redirection URL of the CSMS that actually manages the EV charger. With that, the QR code never has to change, and the association of the EV charger to a CSMS is enough for the QR code to direct the user to the proper Webapp. If no CSMS is associated with the EV charger, instead of redirecting, the landing page can show an advertisement with instructions on how to buy a CSMS for the EV charger, and how to associate the EV charger to the CSMS. If more than one Mobility Service Provider (MSP) is able to control the EV charger, a webpage showing options to the driver can be placed before redirection (this webpage with manual MSP selection is prior art, but using a redirecting QR code to land on the right CPO isn't). The QR codes that only support a single backend are also prior art.

In accordance with one illustrative embodiment of the present invention, an electric vehicle (EV) charger such as an Electric vehicle supply equipment (EVSE) comprises a body and a quick-response (QR) code printed on the body, the QR code being a type of two-dimensional matrix barcode that includes a Uniform Resource Locator (URL) of an Electric vehicle supply equipment (EVSE) manufacturer and being an address of a given unique resource on Internet and can be an HyperText Markup Language (HTML) page, a Cascading Style Sheet (CSS) document, an image followed by a serial number or Device Identification (ID). The QR code covers all Charging Station Management Systems (CSMSs) with a single product stock keeping unit (SKU) and the EV charger works immediately as soon as assigned to a CSMS. The QR code redirects automatically to a desired CSMS, with compatibility to work with more than one CSMS. When a user lands on the URL with a web browser, a Webapp, instead of looking up the EV charger on a specific CSMS, looks up a table that indicates what is a redirection URL of the CSMS that actually manages the EV charger such that the QR code never has to change, and an association of the EV charger to a CSMS is enough for the QR code to direct the user to a desired Webapp.

In accordance with one illustrative embodiment of the present invention, a method provides for a configurable Charge Point Operator (CPO) quick-response (QR) code for seamless commissioning of screenless Electric vehicle (EV) chargers such as an Electric vehicle supply equipment (EVSE). The method comprises providing a body of an EV charger and providing a quick-response (QR) code printed on the body. The QR code being a type of two-dimensional matrix barcode includes a Uniform Resource Locator (URL) of an Electric vehicle supply equipment (EVSE) manufacturer and an address of a given unique resource on Internet and can be an HyperText Markup Language (HTML) page, a Cascading Style Sheet (CSS) document, an image followed by a serial number or Device Identification (ID). The QR code covers all Charging Station Management Systems (CSMSs) with a single product stock keeping unit (SKU) and the EV charger works immediately as soon as assigned to a CSMS. The QR code redirects automatically to a desired CSMS, with compatibility to work with more than one CSMS. When a user lands on the URL with a web browser, a Webapp, instead of looking up the EV charger on a specific CSMS, looks up a table that indicates what is a redirection URL of the CSMS that actually manages the EV charger such that the QR code never has to change, and an association of the EV charger to a CSMS is enough for the QR code to direct the user to a desired Webapp.

The above described features and advantages, as well as others, will become more readily apparent to those of ordinary skill in the art by reference to the following detailed description and accompanying drawings. While it would be desirable to provide one or more of these or other advantageous features, the teachings disclosed herein extend to those embodiments which fall within the scope of the appended claims, regardless of whether they accomplish one or more of the above-mentioned advantages.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects.

FIG. 1 illustrates a smart QR code in accordance with an embodiment of the present invention.

FIG. 2 illustrates an electric vehicle (EV) charger commissioning system using a smart QR code setup in accordance with an embodiment of the present invention.

FIG. 3 illustrates a method of providing an electric vehicle (EV) charger commissioning system using a smart QR code setup in accordance with an embodiment of the present invention.

### DETAILED DESCRIPTION

Various technologies that pertain to systems and methods that provide an electric vehicle (EV) charger commissioning system where a smart QR code setup is provided in that a quick-response (QR) code is printed on a body of an EV charger, and it includes a Uniform Resource Locator (URL) owned by an Electric vehicle supply equipment (EVSE) manufacturer followed by a serial number or Device Identification (ID). The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

To facilitate an understanding of embodiments, principles, and features of the present invention, they are explained hereinafter with reference to implementation in illustrative embodiments. In particular, they are described in the context of an electric vehicle (EV) charger commissioning system. Embodiments of the present invention, however, are not limited to use in the described devices or methods.

The components and materials described hereinafter as making up the various embodiments are intended to be illustrative and not restrictive. Many suitable components and materials that would perform the same or a similar function as the materials described herein are intended to be embraced within the scope of embodiments of the present invention.

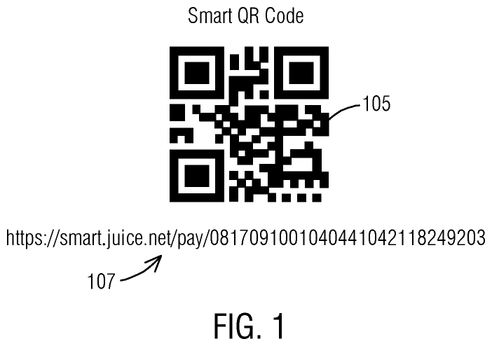

These and other embodiments of the system are provided for providing an electric vehicle (EV) charger commissioning system according to the present disclosure are described below with reference to FIG. 1 herein. The drawing is not necessarily drawn to scale.

Consistent with an embodiment of the present invention, FIG. 1 represents a smart QR code 105 for use in commissioning of an EV charger in accordance with an embodiment of the present invention. FIG. 1 illustrates the smart QR code 105 with an associated URL: https://smart.juice.net/pay/0817091001040441042118249203 107 in accordance with an embodiment of the present invention. The smart QR Code 105 can be read by a QR code reader and generated by a QR code generator. The smart QR code 105 allows a user to redirect users to different destinations based on variables. The user can scan the smart QR code 105 with a Camera app. Open the Camera app from the Home Screen, Control Center, or Lock Screen. Select the rear facing camera. Hold your device so that the smart QR code 105 appears in the viewfinder in the Camera app. Tap the notification to open a weblink associated with the smart QR code 105.

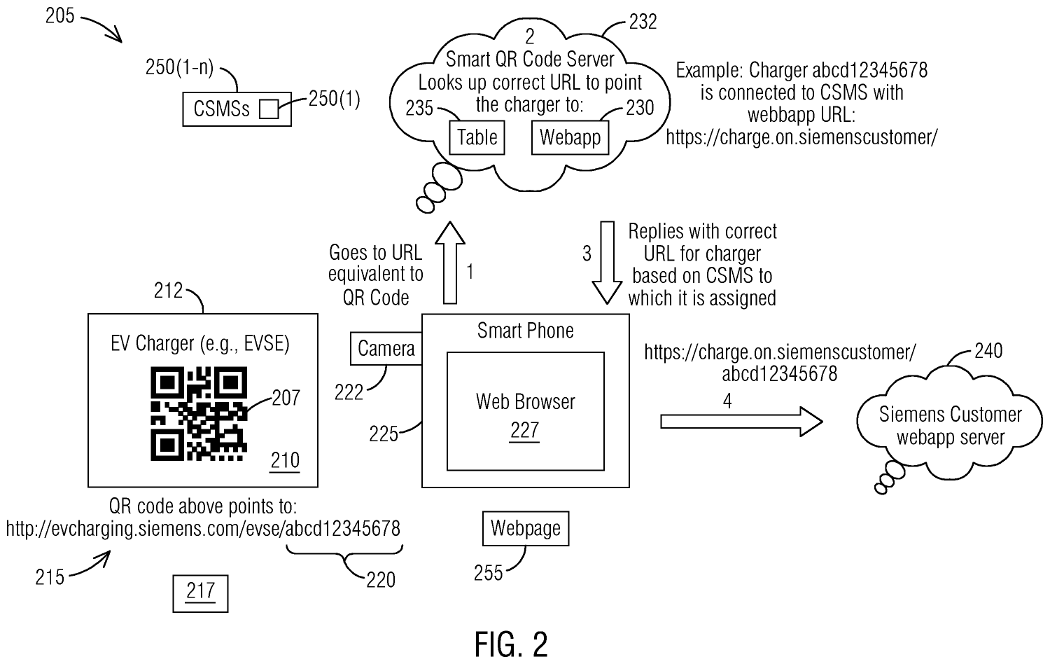

Referring to FIG. 2, it illustrates an electric vehicle (EV) charger commissioning system 205 using a smart QR code based setup in accordance with an embodiment of the present invention. The electric vehicle (EV) charger commissioning system 205 where a smart QR code setup is provided in that a smart quick-response (QR) code 207 is printed on a body 210 of an EV charger 212, and it includes a Uniform Resource Locator (URL) 215 owned by an Electric vehicle supply equipment (EVSE) manufacturer 217 followed by a serial number 220 or Device Identification (ID).

The smart QR code 207 is a computer-generated image with some information encoded in a graphical way. The information may include text, numbers, a URL-pretty much anything an app may need to represent in an encoded manner. What makes QR codes very useful is the encoded information can be then decoded by any device with a camera. Once the smart QR code 207 is scanned, the encoded URL will be opened automatically in a web browser. With a QR code, one can encode any information so users access it without needing to type it in manually. QR codes are digital scannable images that can be used to store and retrieve data. They allow one to link something physical to something digital. For example, one can simply scan a QR code to access a weblink, rather than copying the whole weblink. A QR code is made up of large white and black squares in three of its corners. These squares are called modules. Some of these modules must not be covered or modified, otherwise the QR code cannot be scanned. These are the position markers. They tell the scanner where the edges of the QR Code are. Stripes are called timing patterns. They define the positioning of the rows and columns. In addition, some sections indicate to the reader the format of the QR Code, whether it is a website, a text or other. Finally, modules represent the version number.

The smart QR code 207 can be read with a camera 222 of a smartphone 225 having a web browser 227 installed thereon. A Webapp 230 of a smart QR code server 232 looks up a table 235 to identify a correct URL. The web browser 227 is configured to operate to go to a weblink URL equivalent to the smart QR code 207. The web browser 227 sends a weblink URL https://charge.on.siemenscutomer/abcd12345678 to a siemens customer Webapp server 240. Since the contents of the table 235 can be modified by a user table 235 to a desired setting a configurable Charge Point Operator (CPO) quick-response (QR) code for seamless commissioning becomes possible.

The electric vehicle (EV) charger 212 such as an Electric vehicle supply equipment (EVSE) comprises the body 210. The smart quick-response (QR) code 207 may be coupled or printed on the body 210. The smart QR code 207 being a type of two-dimensional matrix barcode that includes a Uniform Resource Locator (URL) owned by an Electric vehicle supply equipment (EVSE) manufacturer and being an address of a given unique resource on Internet and can be an HyperText Markup Language (HTML) page, a Cascading Style Sheet (CSS) document, an image followed by a serial number or Device Identification (ID).

The smart QR code 207 covers all Charging Station Management Systems (CSMSs) 250(1-n) with a single product stock keeping unit (SKU) and the EV charger 212 works immediately as soon as assigned to a CSMS. The smart QR code 207 redirects automatically to a desired CSMS 250(1), with compatibility to work with more than one CSMS. When a user lands on the URL 215 with the web browser 227, the Webapp 230, instead of looking up the EV charger 212 on a specific CSMS, looks up the table 235 that indicates what is a redirection URL of the CSMS that actually manages the EV charger 212 such that the smart QR code 207 never has to change, and an association of the EV charger 212 to a CSMS is enough for the smart QR code 207 to direct the user to a desired Webapp.

If no CSMS is associated with the EV charger 212, instead of redirecting, a landing webpage can show an advertisement with instructions on how to buy a selected CSMS for the EV charger 212 and how to associate the EV charger 212 to the selected CSMS. If more than one Mobility Service Provider (MSP) is able to control the EV charger 212, a webpage 255 showing options to a driver can be placed before redirection using a redirecting QR code to land on a right Charge Point Operator (CPO). The smart QR code 207 supports a plurality of backends.

The smart QR code 207 points to a weblink URL (as seen in FIG. 2): https://evcharging.siemens.com/evse/abcd12345678. The smart QR code 207 can be read with a camera of a smartphone having a web browser installed thereon. The web browser is configured to operate to go to the weblink URL equivalent to the smart QR code 207. A Webapp of a smart QR code server looks up the table to identify a correct URL to point the EV charger 212 to such that the EV charger 212 abcd12345678 is connected to a CSMS with a Webapp URL https://charge.on.siemenscustomer/. The smart QR code server replies to the web browser with the correct URL for the EV charger 212 based on the CSMS to which it is assigned. The web browser sends a weblink URL (as seen in FIG. 2): https://charge.on.siemenscutomer/abcd12345678 to a siemens customer Webapp server.

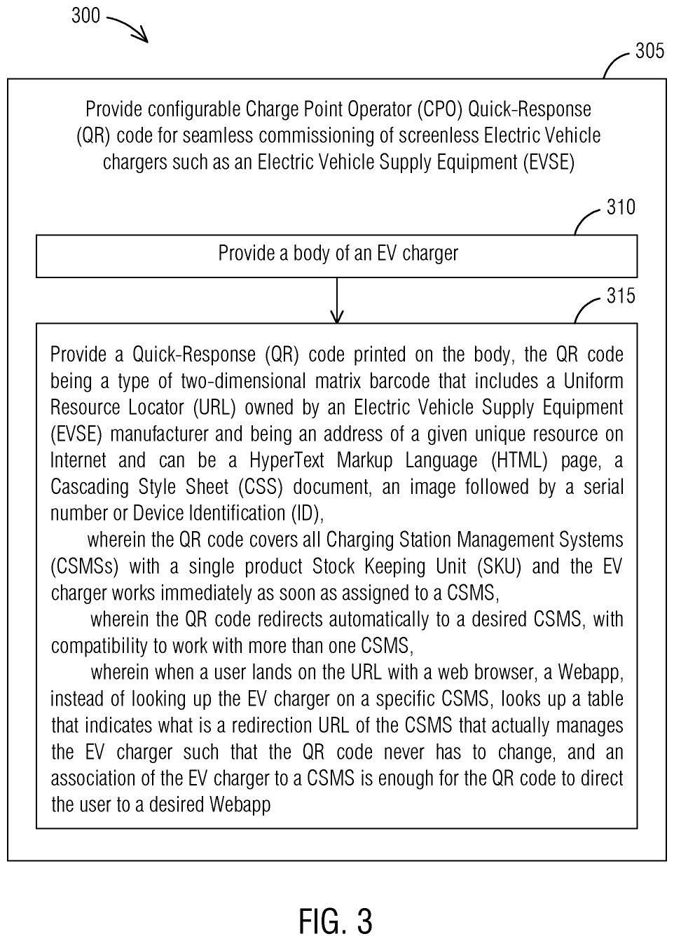

Turning now to FIG. 3, it illustrates a method 300 of providing the electric vehicle (EV) charger commissioning system 205 using a smart QR code setup in accordance with an embodiment of the present invention. Reference is made to the elements and features described in FIGS. 1-2. It should be appreciated that some steps are not required to be performed in any particular order, and that some steps are optional.

The method 300 comprises a step 305 of providing the electric vehicle (EV) charger commissioning system 205 using a smart QR code setup. The method 300 provides configurable Charge Point Operator (CPO) quick-response (QR) code for seamless commissioning of screenless Electric vehicle (EV) chargers such as an Electric vehicle supply equipment (EVSE). The method 300 further comprises a step 310 of providing a body of an EV charger. The method 300 further comprises a step 315 of providing a quick-response (QR) code printed on the body, the QR code being a type of two-dimensional matrix barcode that includes a Uniform Resource Locator (URL) owned by an Electric vehicle supply equipment (EVSE) manufacturer and being an address of a given unique resource on Internet and can be an HyperText Markup Language (HTML) page, a Cascading Style Sheet (CSS) document, an image followed by a serial number or Device Identification (ID).

The QR code covers all Charging Station Management Systems (CSMSs) with a single product stock keeping unit (SKU) and the EV charger works immediately as soon as assigned to a CSMS. The QR code redirects automatically to a desired CSMS, with compatibility to work with more than one CSMS. When a user lands on the URL with a web browser, a Webapp, instead of looking up the EV charger on a specific CSMS, looks up a table that indicates what is a redirection URL of the CSMS that actually manages the EV charger such that the QR code never has to change, and an association of the EV charger to a CSMS is enough for the QR code to direct the user to a desired Webapp.

While an electric vehicle (EV) charger commissioning system based on an Electric Vehicle Supply Equipment (EVSE) is described here a range of one or more other systems are also contemplated by the present invention. For example, other systems may be implemented based on one or more features presented above without deviating from the spirit of the present invention.

The techniques described herein can be particularly useful for any multi-dimensional matrix barcode. While particular embodiments are described in terms of a QR code, the techniques described herein are not limited to such a two-dimensional matrix barcode but can also be used with other types of barcodes.

While embodiments of the present invention have been disclosed in exemplary forms, it will be apparent to those skilled in the art that many modifications, additions, and deletions can be made therein without departing from the spirit and scope of the invention and its equivalents, as set forth in the following claims.

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure embodiments in detail. It should be understood, however, that the detailed description and the specific examples, while indicating preferred embodiments, are given by way of illustration only and not by way of limitation. Various substitutions, modifications, additions and/or rearrangements within the spirit and/or scope of the underlying inventive concept will become apparent to those skilled in the art from this disclosure.

As used herein, the terms “comprises,” “comprising,” “includes,” “including,” “has,” “having” or any other variation thereof, are intended to cover a non-exclusive inclusion. For example, a process, article, or apparatus that comprises a list of elements is not necessarily limited to only those elements but may include other elements not expressly listed or inherent to such process, article, or apparatus.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms.

In the foregoing specification, the invention has been described with reference to specific embodiments. However, one of ordinary skill in the art appreciates that various modifications and changes can be made without departing from the scope of the invention. Accordingly, the specification and figures are to be regarded in an illustrative rather than a restrictive sense, and all such modifications are intended to be included within the scope of invention.

Although the invention has been described with respect to specific embodiments thereof, these embodiments are merely illustrative, and not restrictive of the invention. The description herein of Illustrated embodiments of the invention is not intended to be exhaustive or to limit the invention to the precise forms disclosed herein (and in particular, the inclusion of any particular embodiment, feature or function is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Respective appearances of the phrases “in one embodiment,” “in an embodiment,” or “in a specific embodiment” or similar terminology in various places throughout this specification necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

It will also be appreciated that one or more of the elements depicted in the drawings/figures can also be implemented in a more separated or integrated manner, or even removed or rendered as inoperable in certain cases, as is useful in accordance with a particular application.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

What is claimed is:

1. An electric vehicle (EV) charger such as an Electric vehicle supply equipment (EVSE), the EV charger comprising:
a body; and
a quick-response (QR) code printed on the body, the QR code being a type of two-dimensional matrix barcode that includes a Uniform Resource Locator (URL) of an Electric vehicle supply equipment (EVSE) manufacturer and being an address of a given unique resource on Internet and can be an HyperText Markup Language (HTML) page, a Cascading Style Sheet (CSS) document, an image followed by a serial number or Device Identification (ID),
wherein the QR code covers all Charging Station Management Systems (CSMSs) with a single product stock keeping unit (SKU) and the EV charger works immediately as soon as assigned to a CSMS,
wherein the QR code redirects automatically to a desired CSMS, with compatibility to work with more than one CSMS, and
wherein when a user lands on the URL with a web browser, a Webapp, instead of looking up the EV charger on a specific CSMS, looks up a table that indicates what is a redirection URL of the CSMS that actually manages the EV charger such that the QR code never has to change, and an association of the EV charger to a CSMS is enough for the QR code to direct the user to a desired Webapp.

2. The EV charger of claim 1, wherein if no CSMS is associated with the EV charger, instead of redirecting, a landing webpage can show an advertisement with instructions on how to buy a selected CSMS for the EV charger and how to associate the EV charger to the selected CSMS.

3. The EV charger of claim 1, wherein if more than one Mobility Service Provider (MSP) is able to control the EV charger, a webpage showing options to a driver can be placed before redirection using a redirecting QR code to land on a right Charge Point Operator (CPO).

4. The EV charger of claim 1, wherein the QR code supports a plurality of backends.

5. The EV charger of claim 1, wherein the QR code points to a weblink URL: https://evcharging.siemens.com/evse/abcd12345678.

6. The EV charger of claim 5, wherein the QR code can be read with a camera of a smartphone having a web browser installed thereon.

7. The EV charger of claim 6, wherein the web browser configured to operate to go to the weblink URL equivalent to the QR code.

8. The EV charger of claim 7, wherein a Webapp of a smart QR code server looks up the table to identify a correct URL to point the EV charger to such that the EV charger abcd12345678 is connected to a CSMS with a Webapp URL https://charge.on.siemenscustomer/.

9. The EV charger of claim 8, wherein the smart QR code server replies to the web browser with the correct URL for the EV charger based on the CSMS to which it is assigned.

10. The EV charger of claim 9, wherein the web browser sends a weblink URL https://charge.on.siemenscutomer/abcd12345678 to a siemens customer Webapp server.

11. A method of providing configurable Charge Point Operator (CPO) quick-response (QR) code for seamless commissioning of screenless Electric vehicle (EV) chargers such as an Electric vehicle supply equipment (EVSE), the method comprising:
providing a body of an EV charger; and
providing a quick-response (QR) code printed on the body, the QR code being a type of two-dimensional matrix barcode that includes a Uniform Resource Locator (URL) of an Electric vehicle supply equipment (EVSE) manufacturer and being an address of a given unique resource on Internet and can be an HyperText Markup Language (HTML) page, a Cascading Style Sheet (CSS) document, an image followed by a serial number or Device Identification (ID),
wherein the QR code covers all Charging Station Management Systems (CSMSs) with a single product stock keeping unit (SKU) and the EV charger works immediately as soon as assigned to a CSMS,
wherein the QR code redirects automatically to a desired CSMS, with compatibility to work with more than one CSMS, and
wherein when a user lands on the URL with a web browser, a Webapp, instead of looking up the EV charger on a specific CSMS, looks up a table that indicates what is a redirection URL of the CSMS that actually manages the EV charger such that the QR code never has to change, and an association of the EV charger to a CSMS is enough for the QR code to direct the user to a desired Webapp.

12. The method of claim 11, wherein if no CSMS is associated with the EV charger, instead of redirecting, a landing webpage can show an advertisement with instructions on how to buy a selected CSMS for the EV charger and how to associate the EV charger to the selected CSMS.

13. The method of claim 11, wherein if more than one Mobility Service Provider (MSP) is able to control the EV charger, a webpage showing options to a driver can be placed before redirection using a redirecting QR code to land on a right Charge Point Operator (CPO).

14. The method of claim 11, wherein the QR code supports a plurality of backends.

15. The method of claim 11, wherein the QR code points to a weblink URL: https://evcharging.siemens.com/evse/abcd12345678.

16. The method of claim 15, wherein the QR code can be read with a camera of a smartphone having a web browser installed thereon.

17. The method of claim 16, wherein the web browser configured to operate to go to the weblink URL equivalent to the QR code.

18. The method of claim 17, wherein a Webapp of a smart QR code server looks up the table to identify a correct URL to point the EV charger to such that the EV charger abcd12345678 is connected to a CSMS with a Webapp URL https://charge.on.siemenscustomer/.

19. The method of claim 18, wherein the smart QR code server replies to the web browser with the correct URL for the EV charger based on the CSMS to which it is assigned.

20. The method of claim 19, wherein the web browser sends a weblink URL https://charge.on.siemenscutomer/abcd12345678 to a siemens customer Webapp server.
